(19) United States
(12) Patent Application Publication
(10) Pub. No.: US 2005/0011109 A1
(43) Pub. Date: Jan. 20, 2005

(54) Bobber snap

(76) Inventor: Keith James Valentyne, Kimberly, WI (US)

Correspondence Address: Keith J. Valentyne, 315 Schindler Drive, Kimberly, WI, 54136, US

(21) Appl. No.: 10/619,600

(22) Filed: Jul. 16, 2003

(51) Int. Cl. A01M 23/26

(52) U.S. Cl. 43/89

(57) ABSTRACT

This invention allows you to fasten a bobber to your fishing line easier by having more room with which to insert your line into the fastening apparatus.

### CROSS-REFERENCE TO RELATED APPLICATIONS

This invention is a variation of a conventional fishing bobber (See FIG. 1), a floating device which is attached to your fishing line to suspend your bait and hook off the bottom of the lake and can indicate something pulling on your hook.

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

While ice fishing one winter day I attempted to attach a bobber to my fishing line. This was a conventional round push button spring-loaded type bobber with the small hook that pushes out the bottom when the top button is pushed. (See FIG. 1)

It was a cold and windy day and because it is hard to get your fishing line in the little hook on the bottom on a conventional bobber my hands were frozen. At that time I decided to invent a bobber that was easier to attach to your fishing line by having more room with which to insert your fishing line into the holding device of the bobber.

### BRIEF SUMMARY OF THE INVENTION

This invention consists of a floating sphere (same as a conventional bobber), but the means to attach the bobber to your fishing line is much easier because there is much more room where you insert your line to the attaching device of the bobber. The floating sphere is constructed from two half spheres held together by tension with an elastic cord, spring loaded clip or very light weight spring steel. A first class lever system is employed to open the half spheres apart on one side allowing ample room with which to insert your fishing line, then releasing the pressure on the lever system closed the half spheres back together pinching your fishing line between them and securing the bobber. (See FIG. 2, FIG. 3, and FIG. 4)

### BRIEF DESCRIPTION OF THE SEVERAL VIEWS OF THE DRAWING

FIG. 1 shows a typical bobber with the spring push button and hook attachment system.

FIG. 2 shows my invention using the spring and hinge lever system.

FIG. 3 shows my invention using the spring steel lever system.

FIG. 4 shows my inventions using the elastic cord and pivot system.

FIG. 5 shows the hard plastic used in the elastic cord and pivot system and the spring and hinge system.

FIG. 6 shows how the hard plastic is bent at an angle to form the levers.

FIG. 7 shows how the cord is stretched through the half spheres and then riveted to keep pressure on the cord holding the half spheres together under force.

FIG. 8 shows the elastic cord and pivot system bobber.

FIG. 9 shows the spring and hinge system bobber.

FIG. 10 shows the spring-steel system bobber.

FIG. 11 shows a variation of the elastic cord and lever system bobber.

FIG. 12 shows how the variation of the elastic cord and lever system is opened, by pulling with two fingers and pushing on the buoyant sphere with your other two fingers.

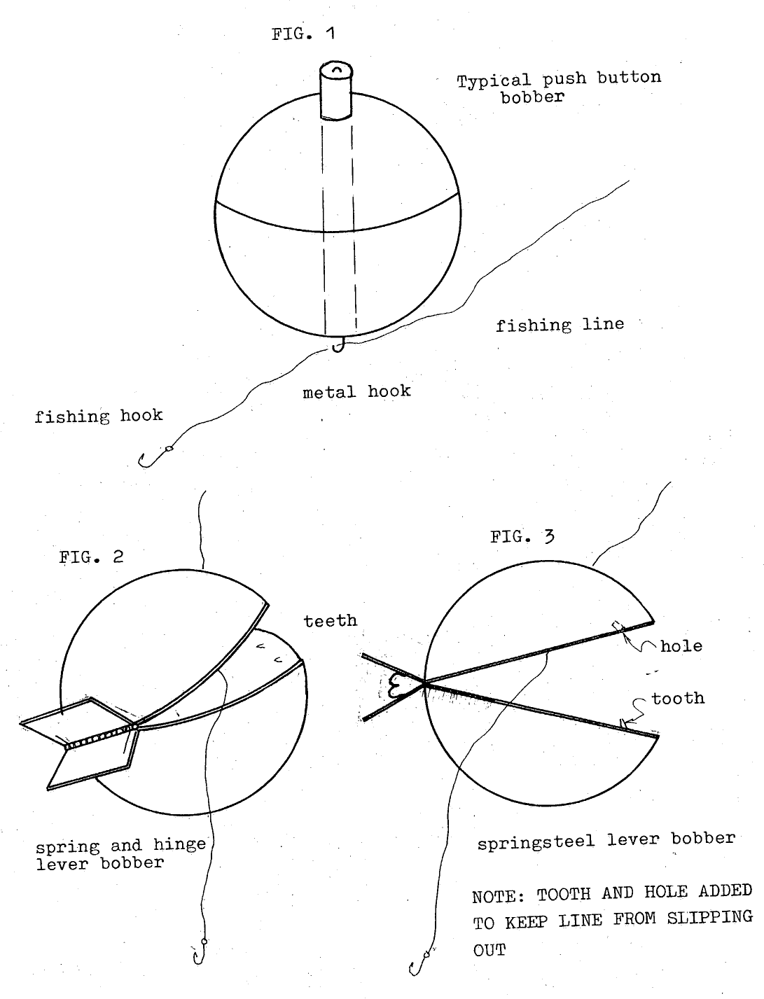

### DETAILED DESCRIPTION OF THE INVENTION

This invention consists of two buoyant half spheres made from either dylite, cork, styrofoam, wood or sealed hollow plastic, held together by an elastic cord, spring and hinge, or spring steel. The half spheres together can be any size from one-half inch to four inches in diameter. Three different methods of accomplishing this invention will be described. My invention is the process of attaching a bobber to your fishing line by opening the half spheres, which are held together under tension with one of the three methods mentioned above, by squeezing the two levers together to force open the other side of the half spheres apart so you can insert your line then release the pressure and pinch your line in between the half spheres.

The first method of accomplishing this invention consists of two half spheres held together under force by a secured piece of stretched elastic cord. This method uses a first class lever system to attach your fishing line to the bobber. Two levers attached to the half spheres can be pinched together to force open the half spheres on the other end where you can insert your fishing line, release pressure and have your line secured to the bobber.

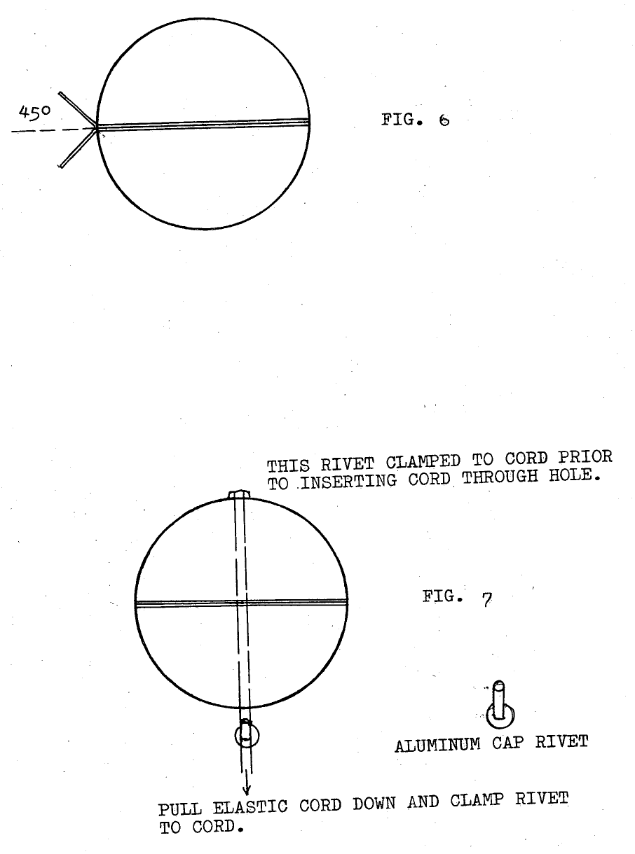

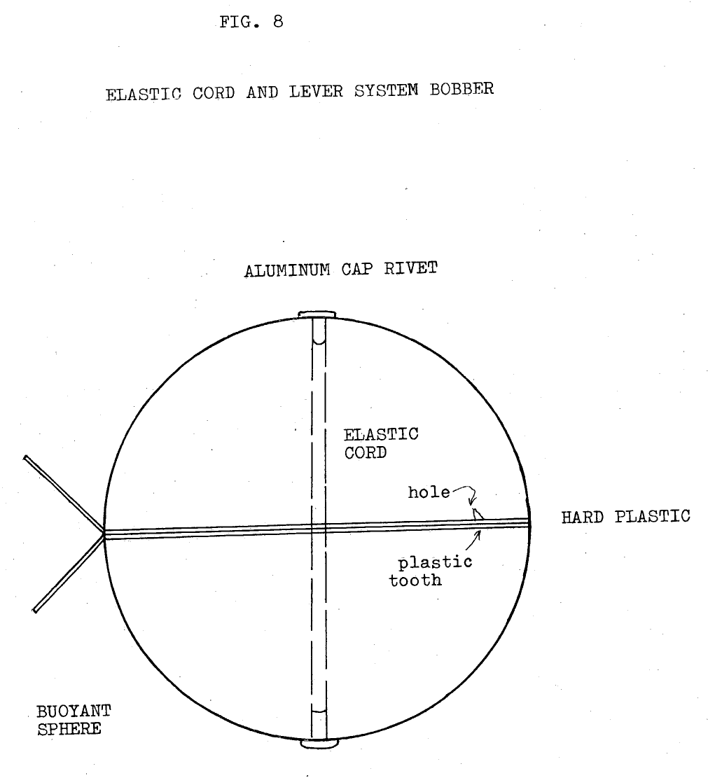

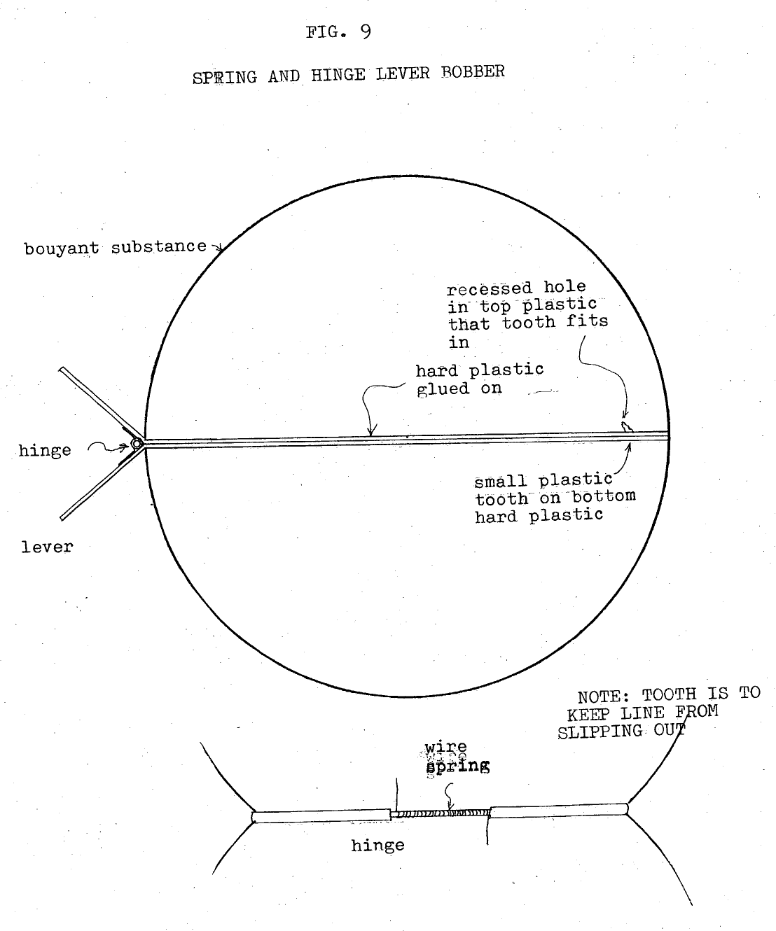

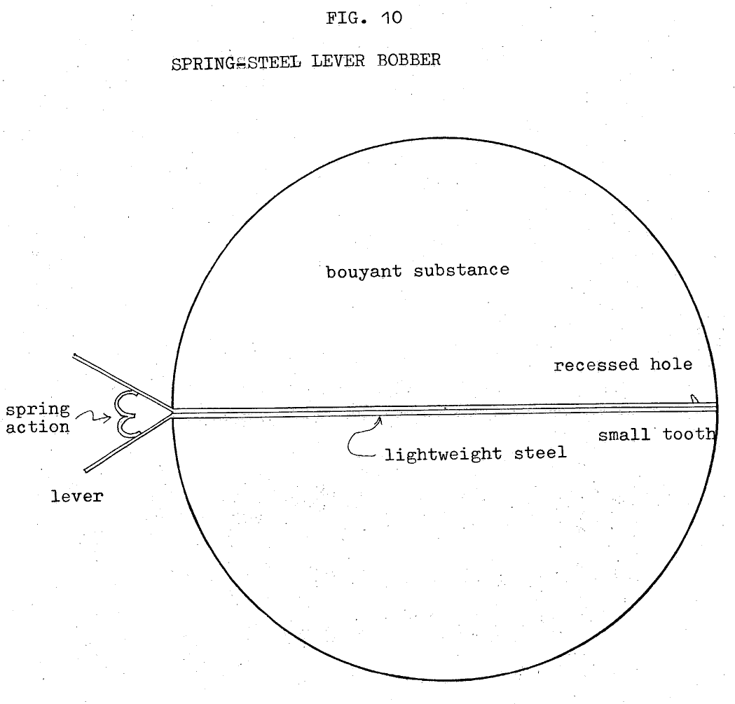

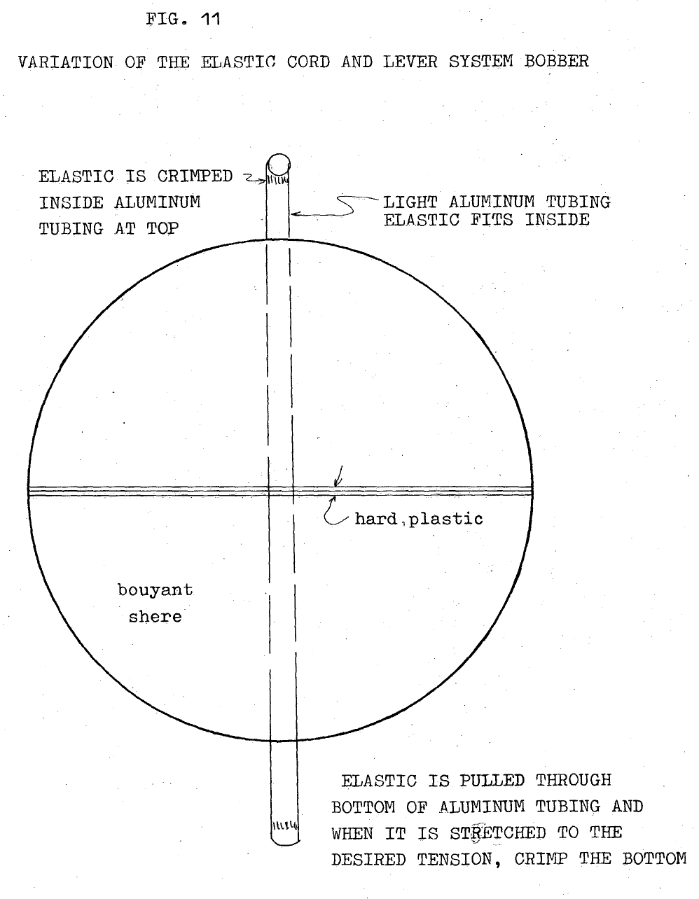

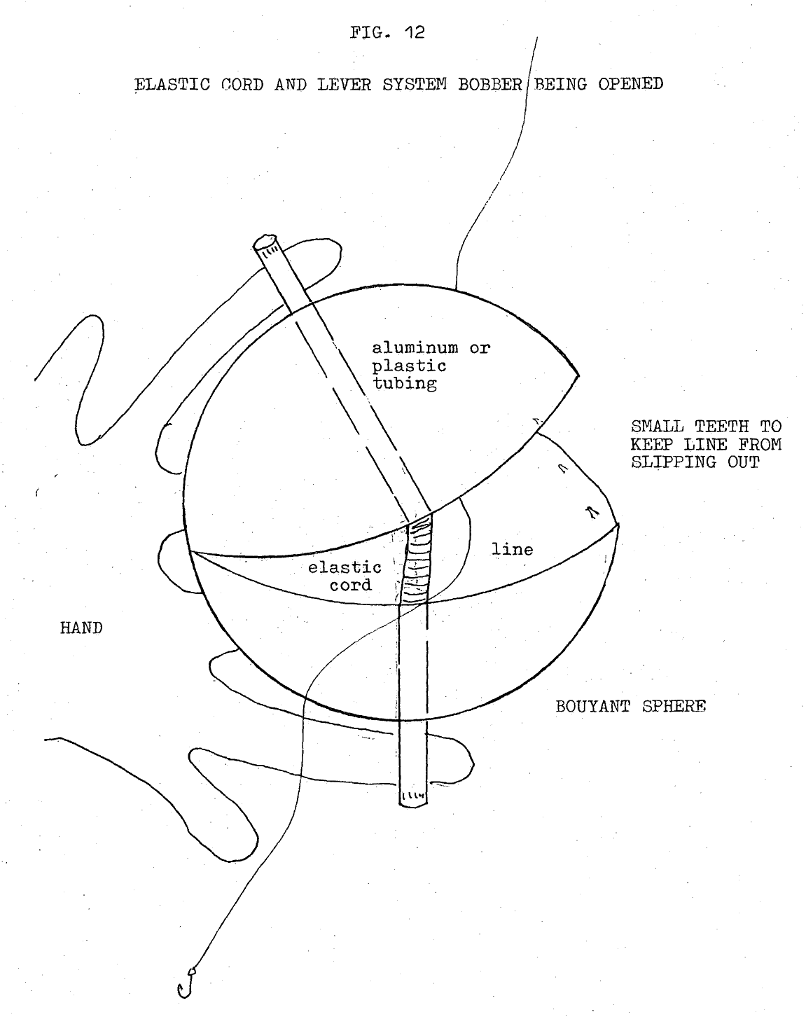

For this example we will use a two-inch diameter sphere. Imagine the sphere as our planet earth. First a ⅛^{th}-inch hole is drilled through the North-South axis of the sphere. Then the sphere is cut in half through the equator. A piece of 1/16^{th}-inch hard plastic is cut to match the circumference of the bottom of the half spheres, except on one side the plastic is left to stick out ¼-inch from the edge of the sphere. (See FIG. 5) These two pieces of hard plastic are then glued with waterproof glue to the bottoms of the half spheres. After the glue is dry the part of the hard plastic that was left sticking out from the body of the half spheres is slightly heated, then bent at a 45-degree angle to the flat bottom part of the spheres. (See FIG. 6) The ⅛^{th} diameter hole that was drilled through the sphere is the re-drilled to extend the hole through the hard plastic pieces that were glued to the bottom of the half spheres. A piece of ⅛^{th}-inch elastic cord is then inserted through the North-South axis hole that was drilled through the sphere as the half spheres are held together. A ⅛^{th}-inch aluminum or plastic cap rivet is then attached to one end of the elastic cord. The other end of the cord that is through the hole drilled through the North-South axis is pulled with some tension stretching it through the middle of the sphere.

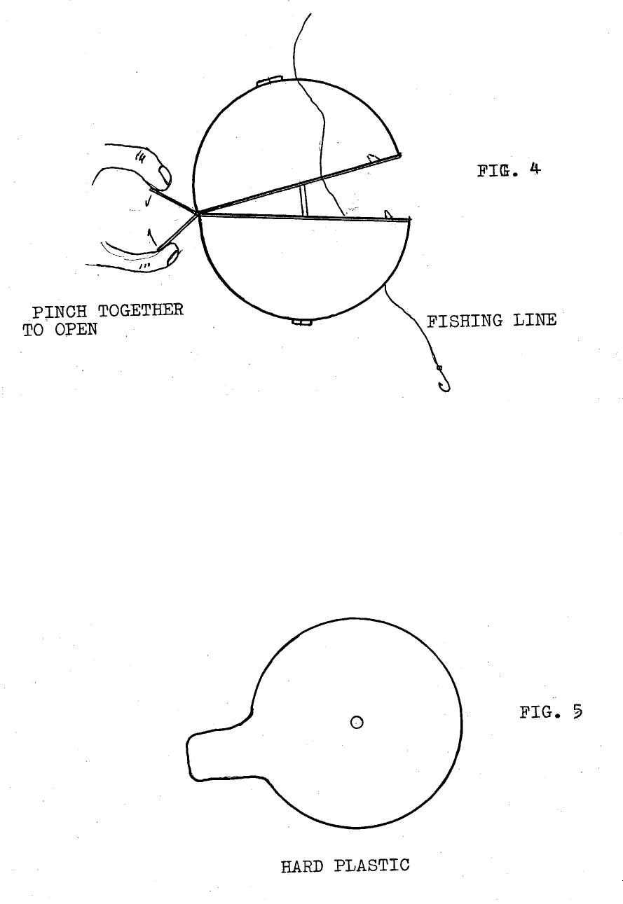

While this tension is applied a cap rivet is applied to the other end of the cord securing the elastic cord to the half spheres and keeping them together under the tension of the stretched elastic cord. (See FIG. 7) Now you can pinch the two levers, the ends of the bent hard plastic, to open the half spheres to about a ½-inch where you can insert your fishing line then let go of the levers and your line will be pinched in between the two half spheres. (See FIG. 4)

The second method of accomplishing this invention uses an outside spring lever hinge system. The buoyant half spheres are attached to flat hard plastic pieces that are hinged together with a coiled spring around the hinge pin. The spring is wound to keep pressure on the half spheres pushing them together. (See FIG. 2)

The third method of accomplishing this invention uses a very thin piece of spring steel attached to the half spheres to apply pressure to hold them together. The spring steel is shaped as shown in (FIG. 3), which is similar to a binder clip. Squeezing the outside levers together pressures the spring steel apart opening the half spheres allowing you to insert your fishing line in between the half spheres then releasing the pressure pinches your line in between the half spheres securing it to the bobber.

2. What I claim as my invention is being easily able to secure a buoyant medium
in this case two dylite, cork or sealed hollow airtight plastic half spheres to your fishing line
using a lever system which would encompass a thin piece of hard plastic attached to the flat surface side of the half spheres and extended out from the half spheres approximately one-half inch and angled at the apex of the sphere 45 degrees to said flat side of the half spheres
so you could apply pressure with your fingertips to push the two angled pieces together thence forcing the two half spheres
which are held together under tension from either a stretched piece of elastic cord through the center axis of the half spheres, said cord attached to half spheres at outside surface or a piece of spring steel attached to the inside flat surface of the extended hard plastic pieces in between the space where they angle out, or a coiled spring wrapped around a hinge at the apex of the half spheres and the hard plastic levers
the hard plastic levers would form a fulcrum at the apex of the two half spheres and when they are pressed together they would open the half spheres apart thereby allowing ample room ¼-1/2 inch with which to insert your fishing line the release the pressure and have your line clamped in between the half spheres.
